(19) United States
(12) Patent Application Publication
(10) Pub. No.: US 2013/0260468 A1
(43) Pub. Date: Oct. 3, 2013

(54) METHODS FOR THE ANALYSIS OF LIQUID HALOSILANES

(71) Applicants: Javier Campo-Manoyo, Bilbao (ES); Antonio Valls-Vaque, Xerta-Tarragona (ES); Maria Tomas-Martinez, Murcia (ES)

(72) Inventors: Javier Campo-Manoyo, Bilbao (ES); Antonio Valls-Vaque, Xerta-Tarragona (ES); Maria Tomas-Martinez, Murcia (ES)

(73) Assignee: Siliken Chemicals, S.L., Casa Ibanez (ES)

(21) Appl. No.: 13/432,962

(22) Filed: Mar. 28, 2012

(51) Int. Cl. G01N 21/59

(52) U.S. Cl. CPC G01N 21/59
USPC 436/72

(57) ABSTRACT

Methods for the direct analysis of liquid halosilanes. In particular, methods for using graphite furnace atomic absorption (GFAA) spectrometric analysis to evaluate the purity of liquid halosilanes by identifying and quantitatively measuring trace elements or impurities, such as, but not limited to metal species that may be present in liquid halosilanes.

### TECHNICAL FIELD

The present disclosure relates to methods for the direct analysis of one or more liquid halosilanes. In particular, this disclosure provides methods for using graphite furnace atomic absorption (GFAA) spectrometric analysis to evaluate the purity of liquid halosilanes by identifying and quantitatively measuring trace elemental impurities such as, but not limited to metal species that may be present in liquid halosilanes.

### BRIEF DESCRIPTION OF THE FIGURES

FIG. 1 is a calibration curve for atomized iron (Fe) at 248.327 nm.

### DETAILED DESCRIPTION

The photovoltaic industry has often sourced silicon material from the microelectronics industry for use in the production of photovoltaic cells and the construction of solar panels. As demand for solar power continues to increase, the photovoltaic industry has recognized the need to actively pursue development of new forms of low-cost solar-grade silicon to meet the increased need for raw materials.

One conventional method of producing polycrystalline silicon is the traditional Siemens method, which involves feeding a mixture comprising a silicon-bearing gas, such as silane (SiH₄), or a mixture comprising a halosilane, such as trichlorosilane (HSiCl₃), into a decomposition reactor. The gases are mixed inside the reactor, decomposed, and deposited heterogeneously onto the surface of a heated silicon filament or rod through chemical vapor deposition. The product obtained from this process is a semiconductor-grade silicon that can be used in the production and manufacture of semiconductors, solar or photovoltaic cells, solar panels and the like.

Electronic-grade silicon is generally silicon with approximately 99.9999999 to 99.999999999% purity (9N to 11N purity). On the other hand, solar-grade silicon is generally silicon with approximately 99.9999 to 99.999999% (6N to 8N purity). Therefore, the purity level of the silicon to be manufactured may vary depending on its final disposition and use. Accordingly, having an analytical method that can reliably and quantitatively measure the amount or concentration of elemental impurities in the raw materials for silicon production is particularly valuable as it can eliminate unnecessary purification steps to save time and reduce cost. In addition, a method capable of quantitatively measuring the metallic impurities content of raw silicon materials can be used as an analytical technique for quality control and quality assurance, before or after a distillation or purification step, to ensure that the raw silicon materials, intermediates, and manufactured silicon products meet the requisite specifications (e.g., purity %).

1. Inductively Coupled Plasma Mass Spectrometry as the Traditional Method for Identifying and Quantitatively Measuring Metal Species in Liquid Halosilane.

Inductively coupled plasma mass spectrometry (ICP-MS) applied to sample digests has been one of the most frequently used methods for the determination of trace elements, such as metal species in raw halosilane materials. As used herein, the term “halosilane” is a silane that includes at least one halogen in its molecular formula. Examples of “halosilane” may include, but are not limited to tetrachlorosilane, trichlorosilane, dichlorosilane, monochlorosilane, tetrabromosilane, tribromosilane, dibromosilane, monobromosilane, tetraiodosilane, triiodosilane, diiodosilane, monoiodosilane, tetrafluorosilane, trifluorosilane, difluorosilane, monofluorosilane, and mixtures thereof.

Conventionally, to identify impurities and quantify any trace elements, such as metal species, in a liquid halosilane using ICP-MS, a sample is taken from the liquid halosilane and subjected to one or more processing steps prior to analysis. First, a sample is taken from the liquid halosilane and hydrolyzed to produce solid silica (SiO₂). Next, the solid SiO₂ is subject to one or more digestion and dissolution steps to dissolve the solid SiO₂. Chemical reagents such as hydrofluoric acid (HF) may be used to digest or dissolve the solid SiO₂ by its volatilization as silicon tetrafluoride (SiF₄) from the sample. After digesting or dissolving the solid SiO₂, the sample can be introduced into an ICP-MS to determine the identity and concentration of any impurities present in the liquid halosilane. The one or more digestion and dissolution steps used during ICP-MS to dissolve the solid SiO₂ increases the risk of contamination, which may lead to undependable results. In addition, the reagents used in the digestion and dissolution steps may give rise to interference, which limits the usefulness of ICP-MS. For instance, HF, a common reagent used to digest SiO₂, may also create an extremely high background reading, which can lead to an overall loss of sensitivity of the analysis. The reagents used in the digestion and dissolution steps may also include harsh or caustic chemicals (e.g., HF) that can be deleterious to and reduce the useful life of various components of the ICP-MS instrument such as, but not limited to the components fabricated from glass or ceramic. Furthermore, the inclusion of one or more digestion and dissolution steps increases reagent and waste disposal costs per sample. In addition, the need to perform one or more digestion and dissolution steps is time consuming and interferes with the efficiency of sample analysis and, consequently, silicon production.

2. Methods for the Analysis of a Liquid Halosilane.

Disclosed herein are methods for the analysis of a liquid halosilane, such as a liquid halosilane sample produced during silicon production. In certain embodiments, the methods disclosed herein comprise the use of graphite furnace atomic absorption (GFAA) spectrometry to analyze the presence or absence of impurities and trace elements, such as metal species, in a liquid halosilane sample. In particular embodiments, the methods disclosed herein comprise the use of GFAA spectrometry to analyze the presence or absence of trace elements, such as metal species, in a liquid halosilane sample, wherein the trace elements may be present in concentrations below approximately one part per million (1 ppm) in a low-volume solid sample. In one embodiment, the liquid sample comprises solid SiO₂ containing other trace elements such as, one or more metal species.

As generally known by those of skill in the art, GFAA spectrometry is an elemental analytical technique designed for the quantitative analysis of liquid and solid samples. This analytical technique is based on the theory that free ground-state atoms will absorb light at frequencies or wavelengths characteristic of the atomic element of interest. In some embodiments of the methods described herein for the analysis of a halosilane sample, GFAA spectrometry employs a graphite furnace, which is an electrothermal atomizer system that can generate temperatures as high as approximately 3,000° C., capable of atomizing liquid and solid samples. The heated graphite furnace provides thermal energy sufficient to break chemical bonds to produce free ground-state atoms. The free ground-state atoms are capable of absorbing energy, in the form of light, and can be elevated to an excited state upon absorption of light at a selected wavelength characteristic of the trace element. Quantitative measurements of trace elements such as metal species may be achieved by selecting the wavelength of light that is absorbed by and characteristic of the metal species. When a sample is believed to comprise certain metal species, the metal species can be irradiated by the one or more selected wavelengths characteristic of the metal species, within the atomized sample. In certain embodiments of the methods disclosed herein, the one or more selected wavelengths characteristic of the metal species may be determined by using the absorption spectrum to identify wavelengths that match the energy difference between two quantum mechanical states of the metal species of interest. The absorbance (Abs) of light energy by the metal species can be calculated according to the following equation:

Abs=ln(I₀/I)

wherein the I₀ represents the incident light intensity at a specific wavelength (intensity of the light before it enters the sample) and I represents the transmitted light intensity (intensity of light that has passed through the sample). Further examples of graphite furnace atomic absorption (GFAA) spectrometry that may be used with the methods disclosed herein are shown, for instance, in Welz B., Sperling, M. Atomic Absorption Spectrometry, 3rd Ed. Wiley-VCH (1999).

The methods disclosed herein for the analysis of a liquid halosilane sample may include methods comprising the preparation of a calibration curve for one or more trace elements. For certain embodiments of the methods disclosed herein, in order to determine the species and quantitatively measure the concentration of a GFAA spectrometry-analyzed element, a plurality of standard solution samples with known concentrations of one or more trace elements and/or metal species can be prepared to establish a calibration curve. The preparation of a calibration curve is understood by those in the art and may be prepared, for example, according to standard methods used for GFAA spectrometry calibration curve preparation. Generally, a calibration curve represents a correlation between the wavelength absorbance and element concentration for an element of interest, such as a particular metal species or impurity. For example, to establish a calibration curve for a metal species of interest, a commercially-available standard atomic absorption solution for the trace element or metal species of interest may be obtained to prepare a stock solution. In certain embodiments of the methods disclosed herein, the metal species of interest may include one or more of nickel (Ni), chromium (Cr), iron (Fe), copper (Cu), molybdenum (Mo), titanium (Ti), cobalt (Co), vanadium (V), cadmium (Cd), zinc (Zn), aluminum (Al), tin (Sn), calcium (Ca), sodium (Na), magnesium (Mg), and lead (Pb). The stock solution for the metal species of interest can be diluted to prepare a plurality of standard solution samples having a range of known concentrations. The ranges of concentrations may vary depending on various factors such as, but not limited to the concentration of the liquid halosilane to be analyzed. In certain embodiments of the methods disclosed herein, a calibration curve may be prepared for one or more trace elements and may comprise the use of a range of known concentrations for the standard solution samples ranging from approximately 0.01 mg/L (0.01 ppb) to 1,000 mg/L (1 ppm). In certain such embodiments, the standard solution samples may be transferred to a graphite cuvette in a GFAA spectrometer to be atomized and analyzed. In other such embodiments, the absorbance readings for one or more metal species in the standard solution samples are measured and can be plotted as a function of their known concentration to establish a calibration curve for each of the metal species of interest.

In certain embodiments, standard solution samples of one or more metal species may be prepared to establish one or more calibration curves that may be used to determine the concentration of the metal species using their corresponding absorbance readings from a GFAA spectrometric analysis. In one embodiment, a stock solution for a given metal species may be used to prepare standard solution samples to generate a calibration curve. The stock solution may be diluted to prepare standard solution samples that form a range of varying concentrations. Examples of diluents suitable for use in preparing the standard solution samples may include de-ionized water (dH₂O), an acid with a concentration of approximately 3 M or less, and the like. In another embodiment, the diluent selected to prepare the standard solution samples may be identical to the blank solution. For those embodiments of the methods disclosed herein comprising a method of establishing a calibration curve, the concentration for each standard solution sample for each trace element or metal species can be independently established to accommodate the different linear ranges unique to each trace element, such as one or more metal species. A GFAA spectrometer such as an Analytik Jena contrAA® 700 can be used to measure the absorbance for one or more elements, such as one or more metal species, that may be found in the standard solution samples with known concentrations. The absorbance readings for one or more trace elements or metal species included at the various known concentrations can be used to generate a calibration curve that plots the absorbance reading as a function of the concentration of the one or more trace elements or metal species. Statistical methods (e.g., least squares regression, line of best fit, removal of outliers, etc) and programs known to one of skill in the art may be used to generate a calibration curve that is sufficiently reliable for use in determining the concentration of a given trace element or metal species, based on an absorbance reading of the trace element or metal species from the GFAA spectrometer for the hydrolyzed sample of halosilane.

Also disclosed herein are methods for direct quantitative analysis of liquid halosilanes using GFAA spectrometry that do not require the more traditional steps of digesting, dissolving, or otherwise removing a solid SiO₂ prior to sample analysis. In certain embodiments of the methods described herein, the liquid halosilane is kept or contained in a closed vial, a moisture-free environment or a vacuum environment prior to GFAA spectrometric analysis to prevent premature hydrolysis of the liquid halosilane. The concentrations for the samples of liquid halosilane to be analyzed may be approximately within the same range of concentrations of the standard solution samples prepared for the calibration curve of the metals species.

In particular embodiments of the methods of analyzing a liquid halosilane, an aliquot of liquid halosilane may be provided and transferred into a graphite cuvette of a GFAA spectrometer. In some embodiments, the aliquot of liquid halosilane deposited in the graphite cuvette may be at least approximately 1-50 μL. In other embodiments of the methods of analyzing a liquid halosilane, a sample of liquid halosilane in a graphite cuvette is provided in a clean environment (e.g., clean fume cupboard) wherein the liquid halosilane is hydrolyzed in air to produce solid SiO₂.

In certain embodiments of the methods described herein, the methods comprise hydrolysis of a liquid halosilane in the presence of water that may be introduced to the liquid halosilane sample to form solid SiO₂. In certain such embodiments, water can be directly added to the halosilane sample, or it can also be introduced in the form of moisture or humidity present in the air. In one particular embodiment, the liquid halosilane is hydrolyzed in air, in a clean environment to prevent any contamination of sample prior to analysis.

In particular embodiments of the methods for analyzing a liquid halosilane disclosed herein, a liquid halosilane may be hydrolyzed wherein any trace elements or impurities (e.g., metal species) that might be present in the liquid halosilane sample become entrapped in the solid SiO₂ produced by hydrolysis of the halosilane. In certain embodiments, the solid SiO₂ produced is substantially a fine powder or precipitation of solid SiO₂. In some embodiments, the liquid halosilane is hydrolyzed in air and produces solid SiO₂ that may include entrapped metal species and, at times, a relatively small or negligible amount of solution that can be readily evaporated, without additional processing steps.

The methods disclosed herein may comprise providing a volume of approximately 1-50 μL of liquid trichlorosilane (HSiCl₃ or TCS) that may then be transferred into a vessel, such as a graphite cuvette for use with a GFAA spectrometer and hydrolyzed to yield solid SiO₂. The hydrolysis of a halosilane, such as trichlorosilane proceeds in accordance with the following chemical reaction:

SiHCl₃+2H₂O→SiO₂+3HCl+H₂.

In certain embodiments of the methods described herein, upon hydrolysis of the liquid halosilane, the resulting solid SiO₂ and any trace elements, such as one or more metal species, can be directly atomized and analyzed using a GFAA spectrometer without further processing steps (e.g., digestion or dissolution steps) to dissolve or otherwise remove the solid SiO₂ from the hydrolyzed sample. In such embodiments, the temperatures and times (e.g., hold times, ramp times) for the atomization programs associated with the GFAA spectrometer can be manipulated, adjusted and programmed accordingly, depending on various factors including, but not limited to the trace elements or metal species of interest. In other such embodiments, the absorbance readings for the one or more metal species of interest can be directly measured from the atomized solid sample by irradiating the metal species of interest with a selected wavelength that is absorbed by and characteristic of the metal species of interest. In certain embodiments, the methods disclosed herein can be used to analyze hydrolyzed samples of halosilane for trace metal species present at or below a one part per million (1 ppm) threshold. In some embodiments, the methods disclosed herein can be used to analyze hydrolyzed samples of halosilane for trace metal species present in the one part per billion (ppb) range.

### EXAMPLES

The specific examples included herein are for illustrative purposes only and are not to be considered as limiting to this disclosure. The compositions referred to and used in the following examples are either commercially available or can be prepared according to standard literature procedures by those skilled in the art.

### Example 1

### Preparation of Standard Solution Samples for Metal Species

Standard atomic absorption solutions (Sigma-Aldrich®, 1,000 mg/L) were obtained for the following metal species: nickel (Ni), chromium (Cr), iron (Fe), copper (Cu), molybdenum (Mo), titanium (Ti), cobalt (Co), vanadium (V), cadmium (Cd), zinc (Zn), aluminum (Al), tin (Sn), calcium (Ca), sodium (Na), magnesium (Mg), and lead (Pb). Each of the standard atomic absorption solutions was diluted with an acid to prepare standard stock solutions with concentrations ranging from 1 to 10 mg/L. Each of the standard stock solutions were further diluted to prepare four standard solution samples for use in preparing calibration curves for their respective metal species.

### Example 2

### GFAA Spectrometric Analysis of Standard Solution Samples and Establishment of Calibration Curve for Metal Species

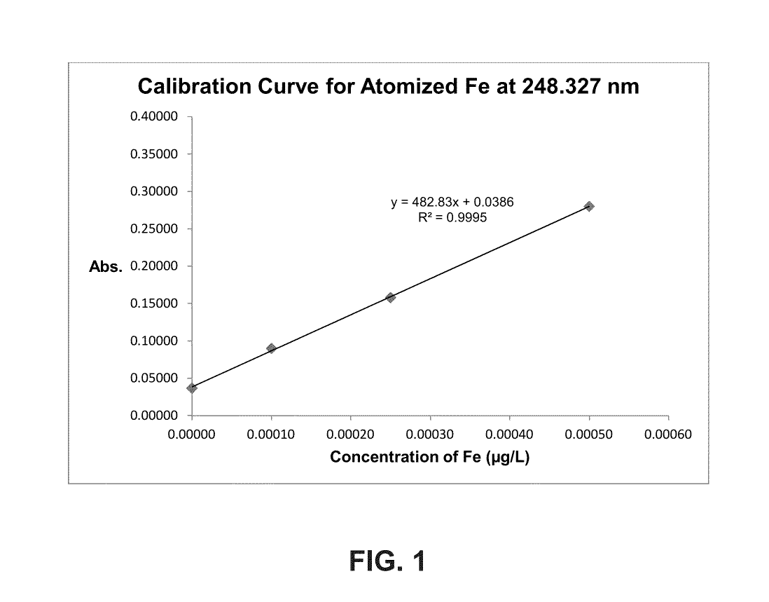

The standard solution samples for each metal species were prepared according to the method in Example 1 and analyzed using a GFAA spectrometer (Analytik Jena contrAA® 700) to measure the absorbance (Abs) for each of the standard solution samples with known concentrations. Calibration curves were prepared for each of the metal species in Example 1 by plotting the absorbance readings as a function of the known concentrations of the standard solution samples. As illustrated in FIG. 1, the measured absorbance (Abs) at 248.327 nm and known concentration (μg/L) for each of the four standard solution samples of Fe were used to generate a calibration curve.

### Example 3

### GFAA Spectrometric Analysis of Liquid Chlorosilane

A liquid chlorosilane having unknown concentrations of Ni, Cr, Fe, Cu, Mo, Ti, Co, V, Cd, Zn, Al, Sn, Ca, Na, Mg and Pb was analyzed using a GFAA spectrometer. A sample of liquid chlorosilane (20 μL) was manually transferred into a graphite cuvette on the GFAA spectrometric platform using micropipette techniques. In a clean environment, a sample of liquid chlorosilane held in a graphite cuvette was hydrolyzed in air to produce solid silica (SiO₂) containing entrapped metal species. The resulting sample of solid SiO₂ containing entrapped metal species was directly analyzed using the GFAA spectrometer to measure and collect absorbance data for each of the metal species of interest. This procedure was repeated three additional times for varying volumes of chlorosilane (20 μL, 30 μL, 25 μL). The absorbance readings for Fe and the corresponding concentrations calculated using the calibration curve in FIG. 1 are provided below in Table 1 for each of the four samples. The average concentration calculated for Fe as provided in Table 1 was 14.7 μg/L (ppb). The relative standard deviation (% RSD) for the calculated average concentration for Fe in Table 1 was 3.2%, which shows consistency and reproducibility of results with manual pipetting.

TABLE 1

| Aliquot # | μL | Abs | Fe μg/L |
|---|---|---|---|
| 1 | 20.000 | 0.17662 | 14.1 |
| 2 | 20.000 | 0.18481 | 15.0 |
| 3 | 30.000 | 0.25004 | 14.5 |
| 4 | 25.000 | 0.22256 | 15.1 |

It will be obvious to those having skill in the art that many changes may be made to the details of the above-described embodiments without departing from the underlying principles of the invention. The scope of the present invention should, therefore, be determined only by the following claims.

1. A method for direct analysis of a liquid halosilane using a graphite furnace atomic absorption (GFAA) spectrometer, the method comprising:
obtaining a sample of liquid halosilane;
hydrolyzing the sample of liquid halosilane,
wherein hydrolyzing the sample produces solid silica; and
analyzing the hydrolyzed sample,
wherein analyzing the hydrolyzed sample comprises directly analyzing the solid silica using the GFAA spectrometer.

2. The method of claim 1, wherein directly analyzing the solid silica using the GFAA spectrometer comprises directly analyzing the solid silica without digesting or dissolving the solid silica.

3. The method of claim 1, wherein the hydrolyzed sample contains at least one trace element, the method further comprising:
preparing at least one calibration curve corresponding to the at least one trace element; and
determining the concentration of the at least one trace element,
wherein determining the concentration of the at least one trace element comprises measuring the absorbance of the at least one trace element and correlating the measured absorbance of the at least one trace element to its concentration using the at least one calibration curve.

4. The method of claim 3, wherein the at least one trace element is a metal species.

5. The method of claim 4, wherein the at least one metal species is selected from at least one of the following: Ni, Cr, Fe, Cu, Mo, Ti, Co, V, Cd, Zn, Al, Sn, Ca, Na, Mg, and Pb.

6. The method of claim 4, wherein the halosilane comprises at least one of the following: tetrachlorosilane, trichlorosilane, dichlorosilane, monochlorosilane, tetrabromosilane, tribromosilane, dibromosilane, monobromosilane, tetraiodosilane, triiodosilane, diiodosilane, monoiodosilane, tetrafluorosilane, trifluorosilane, difluorosilane, monofluorosilane, and mixtures thereof.

7. The method of claim 4, wherein the halosilane comprises a chlorosilane.

8. The method of claim 4, wherein the GFAA spectrometer comprises a graphite cuvette, and wherein the sample of liquid halosilane is hydrolyzed in the graphite cuvette.

9. The method of claim 4, wherein the sample volume of liquid halosilane delivered to the graphite cuvette is between approximately 1 to 50 μL.

10. The method of claim 4, wherein determining the concentration of the at least one metal species is measurable at a level of at least one part per million (1 ppm).

11. The method of claim 4, wherein determining the concentration of the at least one metal species is measurable at a level of at least one part per billion (1 ppb).

12. A method for direct analysis of a liquid halosilane using a graphite furnace atomic absorption (GFAA) spectrometer, the method comprising:
obtaining a sample of liquid halosilane;
hydrolyzing the sample of liquid halosilane,
wherein hydrolyzing the sample produces solid silica,
analyzing the hydrolyzed sample,
wherein analyzing the hydrolyzed sample comprises directly analyzing the solid silica using the GFAA spectrometer without digesting or dissolving the solid silica;
preparing at least one calibration curve corresponding to at least one trace element; and
determining the concentration of the at least one trace element in the hydrolyzed sample,
wherein determining the concentration of the at least one trace element comprises measuring the absorbance of the at least one trace element and correlating the measured absorbance of the at least one trace element to its concentration using the at least one calibration curve.

13. The method of claim 12, wherein the at least one trace element is a metal species.

14. The method of claim 13, wherein the at least one metal species is selected from at least one of the following: Ni, Cr, Fe, Cu, Mo, Ti, Co, V, Cd, Zn, Al, Sn, Ca, Na, Mg, and Pb.

15. The method of claim 12, wherein the halosilane comprises at least one of the following: tetrachlorosilane, trichlorosilane, dichlorosilane, monochlorosilane, tetrabromosilane, tribromosilane, dibromosilane, monobromosilane, tetraiodosilane, triiodosilane, diiodosilane, monoiodosilane, tetrafluorosilane, trifluorosilane, difluorosilane, monofluorosilane, and mixtures thereof.

16. The method of claim 12, wherein the halosilane comprises a chlorosilane.

17. The method of claim 12, wherein the GFAA spectrometer comprises a graphite cuvette, and wherein the sample of liquid halosilane is hydrolyzed in the graphite cuvette.

18. The method of claim 12, wherein the sample volume of liquid halosilane delivered to the graphite cuvette is between approximately 1 to 50 μL.

19. The method of claim 12, wherein determining the concentration of the at least one metal species is measurable at a level of at least one part per million (1 ppm).

20. The method of claim 12, wherein determining the concentration of the at least one metal species is measurable at a level of at least one part per billion (1 ppb).
